(19) United States
(12) Patent Application Publication
(10) Pub. No.: US 2009/0151304 A1
(43) Pub. Date: Jun. 18, 2009

(54) APPARATUS AND METHOD FOR IMPROVED PACKING OF POLYMERIC BAGS

(75) Inventors: Michael A. Ross, Dallas, TX (US); George M. Hall, Colleyville, TX (US)

Correspondence Address: AKIN GUMP STRAUSS HAUER & FELD, LLP, P O BOX 688, DALLAS, TX, 75313-0688, US

(73) Assignee: POLY-AMERICA, LP, Grand Prairie, TX (US)

(21) Appl. No.: 11/947,728

(22) Filed: Dec. 17, 2007

(51) Int. Cl. B65B 31/02; B32B 1/02

(52) U.S. Cl. 53/432; 428/35.7; 53/429; 53/434

(57) ABSTRACT

The present invention provides an improved apparatus, method and system for packing and storing carry-out bags, especially bags known as T-shirt bags. In particular, the present invention comprises providing a packaging bag for securing a plurality of polymeric bags. The polymeric bags may be individually folded, or alternatively, folded as groups of polymeric bags. The polymeric bags are placed in the packaging bag and the air inside the packaging bag is removed. The outside, ambient pressure forces the packaging bag to compress onto the polymeric bags. The resulting packaging is generally dumbbell shaped because of the distribution of material in the polymeric bags which provides numerous advantages as discussed herein.

### CROSS-REFERENCE TO RELATED APPLICATIONS

Not Applicable.

### BACKGROUND OF THE INVENTION

1. Technical Field of the Invention

The present invention relates generally to polymeric bags. More specifically, the present invention relates to improved packaging method for polymeric bags.

2. Description of the Related Art

Polymeric bags are utilized in a number of situations across a variety of industries. Small polymeric bags may be used by consumers for many household purposes such as food storage, while larger polymeric bags are commonly used for refuse collection. All types of polymeric bags can be manufactured relatively inexpensively and in large quantities using only a small amount of source material. Furthermore, most polymeric bags have a significant carrying capacity relative to their own weight, making them ideal for numerous applications, especially in the retail context. In fact, polymeric bags are the most common type of bag used in the retail environment in order to provide a customer with a “carry-out” bag for purchased products.

Carry-out bags are particularly relevant to the present invention in view of their inherent characteristics. Many retail establishments use hundreds, if not thousands, of these bags every day to provide a way for customers to easily carry multiple products of varying sizes. Many “carry-out” bags are also known as “T-shirt” bags because they share a loose resemblance to sleeveless T-shirts, in that they have a large upper opening and a pair of side openings with large handles provided between the side openings and the large upper opening.

For retail establishments, T-shirt bags are generally sold in large quantities, such as 1000-bag units. In most instances, the bags are folded and packaged in cardboard containers for sale to the retail establishment. However, T-shirt bags are not ideally suited for efficient folding and packaging. Many other types of polymeric bags are sold in rolls or folded neatly to reduce the volume of the product for the particular container size. However, because of their shape and construction, T-shirt bags are difficult to fold or roll for efficient packaging.

The construction and structure of T-shirt bags make it difficult both to fold the bags and to provide the bags on a roll. First, T-shirt bags are usually constructed from extremely thin polymeric film, resulting in a bag with relatively low mass. The low mass of the bag makes it extremely sensitive to influxes of small amounts of air which may partially inflate a flattened bag. Heavier polymeric products do not generally suffer from such minor forces as the weight of the product is usually sufficient to counteract normal air currents. While this effect is not problematic with respect to individual carry-out bags, when folding and packaging hundreds of polymeric carry-out bags, the small amount of extraneous air in each bag can result in a significant increase in the total volume of the folded and stacked T-shirt bags. In addition to the “bulking” effect of the air in the bag, the construction and structure of the bags can have a similar effect.

Many carry-out bags are gusseted to provide a more useful product for the end user. Gusseted bags are generally formed by folding the bottom corners of the flattened bag inward between the front and back pieces of polymeric film. The inward-folded bottom corners may be positioned along the bottom edge of the polymeric bag and sealed together with the bottom of the bag. The gusseting process provides a “square” bottom for the bag, providing a bag that has both a strong bottom and better defined side walls. However, the gusseted bottom results in a bag that is more likely to expand naturally from a flattened configuration. Specifically, the gusseted bottom induces a minor “spring effect”, making it even easier for air to get trapped inside the bag during manufacture and packaging. While the “spring effect” is desirable for the end consumer, making it easier to place retail products in the bag, it is undesirable when folding and stacking the bags for packaging. The “spring effect” only exacerbates the problem of air being trapped inside the bag.

To eliminate the excess air trapped inside the folded bags, it is common to provide a weight or downward force on the bag shortly before the packaging process to attempt to remove as much air from the bags as possible. Unfortunately, this process is only marginally effective. After the product is placed into the packaging, usually a cardboard container, the shifting and movement of the bags, as well as the previously described spring effect, results in excess air being introduced into the bags. Therefore, the bags require a larger box than would ordinarily be necessary. The need for a box larger than necessary is further aggravated by the unequal distribution of the polymeric material across the area of the product container.

Carry-out bags are usually folded for packaging in groups of 50-100 bags. Each bag of the group is oriented in the same direction so the retailer can quickly remove and use individual bags from the group. Several folded groups of bags are stacked upon each other in the packaging, such as a cardboard container, after they are compressed to remove extra air. However, the design and construction of the carry-out bags result in the majority of the polymeric material being located near the left and right side of the folded groups. On the other hand, along the center-line of the folded bags, there is significantly less polymeric material due to the gusseted construction and cut-out for the primary opening. While the cardboard packaging provides a limited amount of structural rigidity and protection, the minimal quantity of material near the center of the box makes the packaging more susceptible to crushing. Crushed packaging is undesirable by retailers, even if the carry-out T-shirt bags inside are not adversely affected by the crushed packaging.

Environmental concerns also make cardboard packaging less desirable. As already discussed, the cardboard packaging is not efficient for containing the product packaging, because it requires more material than would otherwise be necessary. In addition, although the cardboard packaging can be recycled, it is much more difficult to store cardboard packaging than other types of containers. This is particularly true when compared with the container disclosed as the present invention.

Therefore it would be desirable to provide an improved product packaging for T-shirt bags and similar types of polymeric bags. It would be desirable for such product packaging to optimally contain and hold the T-shirt bags in the smallest possible volume. Further, it would be desirable if the product packaging was lightweight, easily-managed, and more environmentally sensitive than bulky cardboard packaging. The present invention addresses these needs and provides further advantages over the prior art solutions.

### SUMMARY OF THE INVENTION

The following description and the appended drawings set forth in detail certain illustrative embodiments of the present invention. These embodiments are only exemplars of but a few of the various ways in which the principles of the invention may be employed. There has thus been outlined, rather broadly, features of the invention in order that the detailed description thereof that follows may be better understood, and in order that the present contribution to the art may be better appreciated.

The present invention provides an improved method for packaging and storing carry-out bags, especially T-shirt bags. In particular, the present invention comprises providing a packaging bag for securing a plurality of polymeric bags. The polymeric bags may be individually folded, or alternatively, folded as groups of polymeric bags. The polymeric bags are placed in the packaging bag and the air inside the packaging bag is removed. The outside, ambient pressure forces the packaging bag to compress onto the polymeric bags. The resulting packaging is generally dumbbell shaped because of the distribution of material in the polymeric bags which provides numerous advantages as discussed herein.

### BRIEF DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

FIG. 1 provides a perspective view of a T-shirt bag as known in the prior art to illustrate the features of the bag that make the present invention advantageous.

FIG. 2A provides a perspective, overhead view of a flattened T-shirt bag, as depicted in FIG. 1, to better illustrate the advantages of the present invention.

FIG. 2B provides a perspective, overhead view of a once-folded flattened T-shirt bag, as depicted in FIG. 1 and FIG. 2A, to better illustrate the advantages of the present invention.

FIG. 3A provides a perspective view of the packaging as contemplated by one embodiment of the present invention.

FIG. 3B provides an elevation view of the packaging as contemplated by one embodiment of the present invention.

FIG. 4 provides an elevation view of a stacking configuration of multiple packaged units as provided by one embodiment of the present invention.

### DETAILED DESCRIPTION OF THE DRAWINGS

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

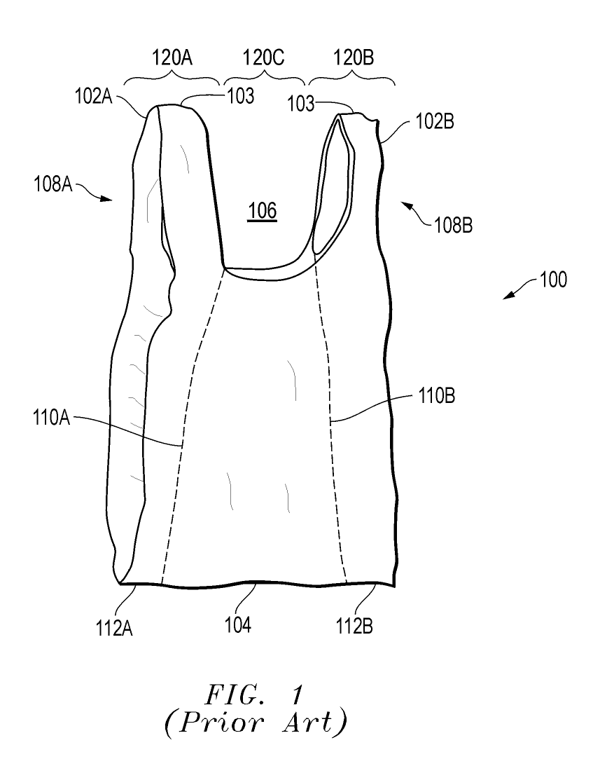

Referring first to FIG. 1, a perspective view of a traditional polymeric carry-out bag, sometimes known as a T-shirt bag, is provided for reference to assist in understanding the advantages and features of the present invention. The plastic carry-out bag 100 is provided with a first handle 102A and a second handle 102B. Between the two handles 102A and 102B, the plastic carry-out bag 100 has a primary opening 106 for placing products inside the bag. This opening is generally formed by removing a sizeable portion of the upper, central area of the carry-out bag 100. Similarly, the handles 102A and 102B are further defined by cutting out the top-left and top-right portions of the carry-out bag 100. The removed material provides a pair of smaller, secondary openings 108A, 108B.

In many designs of carry-out bags, such as the depicted embodiment of FIG. 1, the sides 110A and 110B of the bag 100 is gusseted to provide a more useful bag for carrying various products. With the gusseted carry-out bag 100, the sides 110A and 110B of the bag 100 are folded inwardly between the top and bottom layer of polymeric material. The inwardly-folded sides 110A and 110B are sealed with the top 103 and bottom 104 of the bag 100. The resulting gusseted carry-out bag is more “open,” with a more “square-like” bottom and provides a more cylindrically shaped outer wall compared to a non-gusseted flat bag. The gusset construction can be seen in FIG. 1 where the first and second sides 110A and 110B are inwardly folded along the entire length of the bag 100 with the gusseted lower corners 112A and 112B sealed into position at the same time the bottom edge 104. Similarly, the inwardly-folded sides 110A and 110B frequently extend further than the width of the handles 102A and 102B. All four layers of the handles 102A and 102B are secured together at the top 103 of the bag 100. This configuration is desirable for many applications, as it provides a bag that is easier to work with and has a stronger bottom. Furthermore, the inwardly folded sides 110A and 110B also provide an additional layer of polymeric material for the handles 102A and 102B, thereby making them stronger.

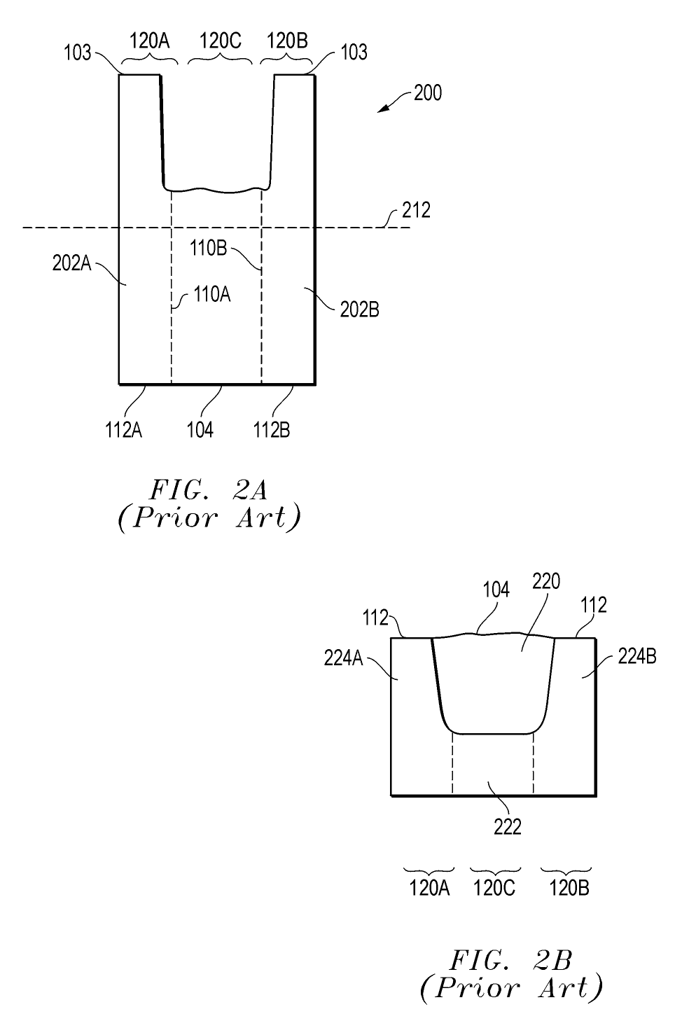

When the bag depicted in FIG. 1 is flattened, it becomes very clear that the left area 120A and right area 120C of the bag have significantly more mass than the central area 120B of the carry-out bag 100. In the depicted embodiment, the carry-out bag 100 is roughly divided into three areas of equal width, providing a left third 120A, a central third 120C, and a right third 120B. Both the left and right areas 120A and 120B have additional material solely due to the location of the handles 102A and 102B in those respective areas. Furthermore, the gusseted design of the bag 100 also results in the sides 110A and 110B of the bags being internally folded when the bag is flattened, resulting in four layers of polymeric material in the left and right areas 120A and 120B of the carry-out bag 100. The flattened bag is better illustrated with reference to FIG. 2A.

FIG. 2A depicts a flattened T-shirt bag 200 ready for packaging according to the present invention. As can be seen, the bag is identical to the bag of FIG. 1, but is depicted in a flattened configuration to better illustrate the four layers of material that result from the gusseting process in the areas denoted by 202A and 202B which also include the multi-layer handles 102A and 102B. These areas are demarcated by the dashed line which represents the internally folded sides 110A and 110B of the carry-out bag 100.

In preparation for packaging, the carry-out bag 100 is generally folded once, usually in groups of multiple bags. For example, each group of folded bags may contain fifty to one hundred bags stacked on top of one another and folded together. To best illustrate the present invention, the figures are depicted with reference to a single bag, but a person having ordinary skill in the art would instantly recognize that multiple flattened T-shirt bags as depicted in FIG. 2A may be immediately stacked upon each other and folded together across line 212. The resulting folded bag, or group of bags, is better depicted by FIG. 2B.

Looking at FIG. 2B, the multiple layers of polymeric material are better identified by area, or region of the bag. For example areas 224A and 224B comprise a total of eight layers of polymeric material. Specifically, the front layer of material, the back layer of material, and the two layers of the inwardly folded gusseted material are folded over axis 212 (as shown in FIG. 2A) and result in the eight layers of polymeric material. On the other hand, area 222 is only four layers of polymeric material while area 220 is a mere two layers thick. Thus, FIG. 2B helps illustrates how a significant amount of the total polymeric material is located in the left third 120A and the right third 120B and not to the central third 120C of the bag 100.

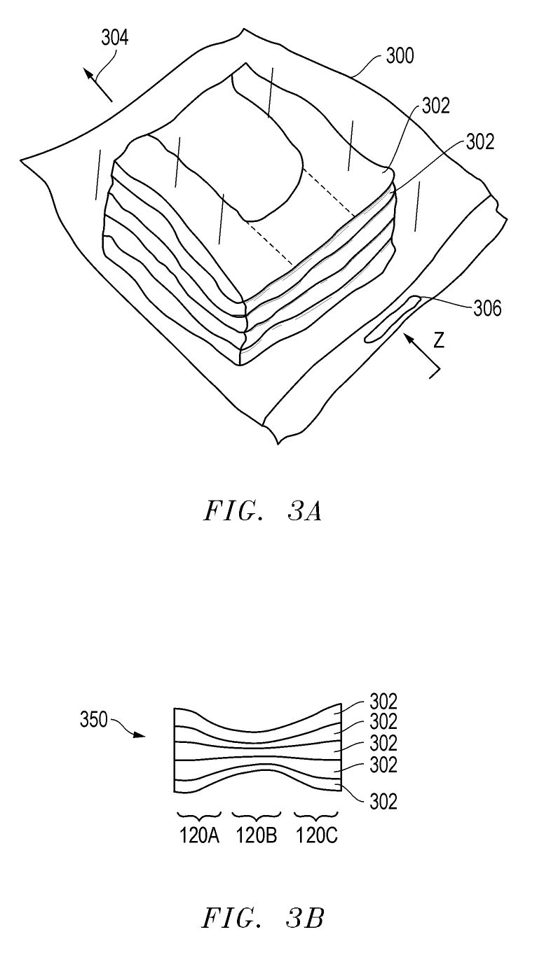

Looking now at FIG. 3A, a perspective view of the packaged polymeric bags according to one embodiment of the present invention is presented. In particular, FIG. 3A illustrates a stack of folded polymeric bags, with multiple folded polymeric bags in each folded group of bags 302. FIG. 3A illustrates a stack of five folded groups of bags 302, but a person having ordinary skill in the art would instantly recognize that any number of folded groups may be utilized without diverging from the spirit of the present invention. The folded groups of bags 302 are stacked and placed inside one embodiment of the present invention, a polymeric packaging bag 300. In the preferred embodiment, each folded group of bags 302 is oriented and stacked in the same direction as the other group of folded bags. Furthermore, the packaging bag 300 may be provided with a handle 306 which is preferably integrated with the packaging bag 300.

After placing a stack of the folded groups of bags 302 inside the polymeric packaging bag 300, a vacuum or partial pressure is provided to remove air from the packaging bag 300 as illustrated by arrow 304. The removal of the air from the interior of the packaging bag 300 causes the bag to collapse. As the air is further removed, the packaging bag 300 further collapses onto the stack of the groups of bags 302, compressing those bags as well. Eventually the air pressure inside the packaging bag 300 drops to a sufficient degree that the outside pressure on the packaging bag 300 forces the stack of groups of bags 302 to compress significantly inward. As the amount of material along in the central area 120C is significantly less than the material in the left and right areas, 120A and 120B, of the individual bags, the central area 120C will compress to a greater degree than the left and right areas 120A and 120B. The final result is a compressed packaging bag 350 which is better illustrated with reference to FIG. 3B by providing an end-on elevation view of the compressed bag from the direction shown by arrow Z in FIG. 3A.

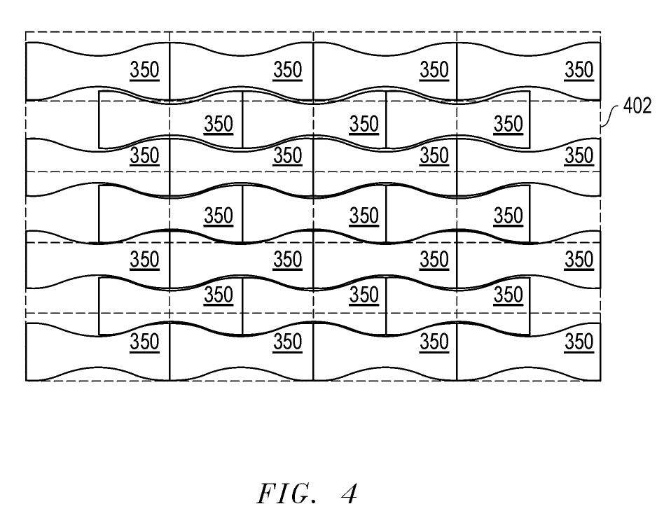

FIG. 3B provides an end-on, elevation view of the compressed packaging bag 350 with the stack of folded groups of bags 302. The depicted illustration reflects an embodiment of the present invention after removing a significant amount of the air inside the packaging bag 300. After removal of the air, the compressed packaging bag 350 is sealed shut to prevent air from reentering the packaging bag 350. This sealing process keeps the compressed packaging bag 350 in a stable configuration, specifically a compressed dumbbell configuration. As can be seen in FIG. 3B, the groups of folded groups of polymeric bags 302 are stacked, with each group being substantially narrower in the central area 120C than the left or right areas 120A and 120B. In addition to having a volume that is significantly less than the prior art cardboard packaging method, the resulting dumbbell configuration also provides further advantages for transportation and packaging as better described with reference to FIG. 4.

FIG. 4 illustrates an elevation view of the dumbbell-shaped compressed packaging bags 350 as would be stacked to illustrate one of the advantages of the present invention. Specifically, it can be seen that the stacked compressed packaging bags 350 can be offset so multiple compressed packaging bags 350 take up less room when stacked on a pallet for distribution or sale. In particular, each row of compressed packaging bags 350 is offset by one-half of the width, such that the taller ends of the compressed packaging bags 350 rest in the valleys formed by the narrower central portion of the compressed packaging bag 350. Dashed lines 402 are intended to represent the size and volume of prior-art cardboard packaging with respect to the compressed packaging bags 350. The decreased volume of the compressed packaging bags 350 allow for extra packages to be provided in the same amount of space. Therefore, the present invention may increase the number of packages, and carry-out bags, that may be stored in the same overall volume by 25% or more.

The dumbbell-shaped packaging bags 350 also require substantially less material than a traditional cardboard package, while also being easier to recycle with other plastic products. Furthermore, since both the interior contents, i.e. the groups of polymeric bags 302 and the outer packaging bag 350 are made from identical polymeric materials, a plastics manufacturer can create both the packaging and the product without relying on a third-party cardboard packaging supplier.

What is claimed is:

1. An improved packing of polymeric bags comprising:
a plurality of polymeric bags wherein each polymeric bag defines a left area, a central area, and a right area, and wherein each polymeric bag has less polymeric material in the central area of the polymeric bag than in the left area of the polymeric bag or in the right area of the polymeric bag, and
a packing container bag surrounding the plurality of polymeric bags, wherein the packing container bag forms a substantially air-right container around the plurality of polymeric bags.

2. The improved packing of polymeric bags of claim 1, wherein each polymeric bag is a T-shirt bag.

3. The improved packing of polymeric bags of claim 1, wherein each polymeric bag is folded over a lateral axis.

4. The improved packing of polymeric bags of claim 3, wherein a group of polymeric bags if stacked together before folding the group of polymeric bags over the lateral axis.

5. The improved packing of polymeric bags of claim 1, wherein the packaging bag is polymeric.

6. The improved packing of polymeric bags of claim 1, wherein each of the polymeric bags is gusseted.

7. The improved packing of polymeric bags of claim 1, further comprising:
a handle for the packaging bag.

8. The improved packing of polymeric bags of claim 5, wherein the handle for the packaging bag is integrated with the packaging bag.

9. An improved method for packing a plurality of polymeric bags, comprising the steps of:
providing a plurality of polymeric bags,
stacking the plurality of polymeric bags,
placing the plurality of polymeric bags into a packaging bag,
removing a substantial amount of the air inside the packaging bag so as to provide a compressed packaging bag having a plurality of polymeric bags therein.

10. The improved method for packing a plurality of polymeric bags of claim 7, further comprising the step of:
folding a plurality of polymeric bags.

11. The improved method for packing a plurality of polymeric bags of claim 8, further comprising the step of:
separating the plurality of polymeric bags into a plurality of groups of polymeric bags wherein each group of polymeric bags is folded as a group.

12. An improved system for packing a plurality of polymeric bags comprising:
a plurality of polymeric bags,
a packaging bag enclosing the plurality of polymeric bags, the packaging bag being sealed to be substantially air-tight, and
removing the air from the packaging bag.
